(19) United States
(12) Patent Application Publication
(10) Pub. No.: US 2026/0246867 A1
(43) Pub. Date: Aug. 20, 2026

(54) IN-VEHICLE COMMUNICATION APPARATUS, IN-VEHICLE SYSTEM AND APPLICATION PROCESSING METHOD BY IN-VEHICLE COMMUNICATION APPARATUS

(71) Applicant: Mitsubishi Electric Mobility Corporation, Tokyo (JP)

(72) Inventors: Yuji HAMADA, Tokyo (JP); Hiroshi AIZAWA, Tokyo (JP); Daisuke SUZUKI, Tokyo (JP)

(73) Assignee: Mitsubishi Electric Mobility Corporation, Tokyo (JP)

(21) Appl. No.: 19/161,947

(22) PCT Filed: Apr. 7, 2023
(86) PCT No.: PCT/JP2023/014326

§ 371 Date: Sep. 3, 2025

(51) Int. Cl. H04M 1/72409

(52) U.S. Cl. CPC H04M 1/724098

(57) ABSTRACT

An in-vehicle communication apparatus which includes: a vehicle-internal communication unit that communicates with in-vehicle apparatuses through an in-vehicle network; a vehicle-external communication unit that communicates with a vehicle outside apparatus; and a control unit having an application profile management unit that determines a combination of apparatuses required, respectively, for acquiring input information that is needed for execution of an application and transferring the input information, for executing processing according to the application, and for outputting a processing result, and a data processing instruction unit that instructs the apparatuses of the combination determined by the application profile management unit, to acquire and transfer the input information, to execute the processing according to the application, and to output the processing result. An in-vehicle system and an application processing method which are established by the in-vehicle apparatuses and the in-vehicle communication apparatus.

### TECHNICAL FIELD

The present application relates to an in-vehicle communication apparatus, an in-vehicle system, and an application processing method by an in-vehicle communication apparatus.

### BACKGROUND ART

With respect to a driving safety support system (DSSS: Driving Safety Support System) using wireless communications, a technique has been proposed in which a communication apparatus installed in a vehicle exchanges position information with a nearby vehicle, a roadside apparatus, etc. to thereby reduce risks of collision. In order to detect a current position and a motional state of the vehicle, a GNSS (Global Navigation Satellite System), an acceleration sensor, a gyro sensor and the like are installed as in-vehicle devices of the driving safety support system, to thereby perform support of driving in linkage with other devices/apparatuses such as a navigation apparatus, a TCU (Telematics Control Unit) and the like.

In order to perform support of driving, information provided by the multiple apparatuses and processing devices provided in the multiple apparatuses should be efficiently utilized. A technology is disclosed that establishes a vehicle driving support system by linking together an in-vehicle apparatus, a navigation apparatus and a smartphone (for example, Patent Document 1).

### CITATION LIST

### Patent Document

Patent Document 1: Japanese Patent Application Laid-open No.2013-238942

### SUMMARY OF INVENTION

### Technical Problem

According to the technology disclosed in Patent Document 1, when an application for vehicle driving support is invoked, a linkage unit of the mobile terminal performs, together with a linkage unit of the in-vehicle apparatus, processing for communication linkage so that the mobile terminal can transmit/receive data to/from the in-vehicle apparatus. This links together the in-vehicle apparatus, the navigation apparatus and the smartphone to thereby establish a vehicle driving support system.

In the technology of Patent Document 1, however, there is no mention on determining, when there are plural choices of in-vehicle apparatuses for establishing the vehicle driving support system, which one of combinations with these in-vehicle apparatuses is to be selected. In cases where multiple in-vehicle apparatuses can be utilized for detecting the position of the vehicle and the motional state of the vehicle, an adequate combination with the in-vehicle apparatus should be selected.

The present application has been made to solve the above problem, and an object thereof is to provide an in-vehicle communication apparatus and an in-vehicle system which can determine, in cases where there are multiple in-vehicle apparatuses each provided with a sensor and a processing device that are usable for execution of an application, an adequate combination with the in-vehicle apparatus to thereby execute the application in linkage with that in-vehicle apparatus; and to provide an application processing method by the in-vehicle communication apparatus.

### Solution to Problem

An in-vehicle communication apparatus according to the present application comprises:
a vehicle-internal communication unit that communicates with in-vehicle apparatuses installed in a vehicle through an in-vehicle network;
a vehicle-external communication unit that communicates with a vehicle outside apparatus placed outside the vehicle; and
a control unit which has:
an application profile management unit that determines a combination of apparatuses that are required, respectively, for acquiring input information that is needed for execution of an application and transferring the input information, for executing processing according to the application on a basis of the transferred input information, and for outputting a processing result of the thus-executed processing according to the application; and
a data processing instruction unit that instructs the apparatuses of said combination determined by the application profile management unit, to acquire and transfer the input information, to execute the processing according to the application on the basis of the transferred input information, and to output the processing result of the executed processing;
wherein the application profile management unit determines from among the in-vehicle apparatuses and the in-vehicle communication apparatus, the combination of apparatuses that are required, respectively, for acquiring and transferring the input information, for executing the processing according to the application and for outputting the processing result.

An in-vehicle system according to this application comprises the in-vehicle apparatuses and the in-vehicle communication apparatus.

An application processing method by an in-vehicle communication apparatus according to this application comprises:
with respect to the in-vehicle communication apparatus which comprises: a vehicle-internal communication unit that communicates with in-vehicle apparatuses installed in a vehicle through an in-vehicle network; a vehicle-external communication unit that communicates with a vehicle outside apparatus placed outside the vehicle; and a control unit which has an application profile management unit and a data processing instruction unit,
an application execution allocation determination step in which the application profile management unit determines a combination of apparatuses that are required, respectively, for acquiring and transferring input information that is needed for execution of an application, for executing processing according to the application on a basis of the transferred input information, and for outputting a processing result of the thus-executed processing according to the application; and
an application execution instruction step in which the data processing instruction unit instructs the apparatuses of said combination determined by the application profile management unit, to acquire and transfer the input information, to execute the processing on the basis of the transferred input information, and to output the processing result of the executed processing.

### Advantageous Effects of Invention

According to the in-vehicle communication apparatus, the in-vehicle system and the application processing method by the in-vehicle communication apparatus in accordance with the present application, it is possible to provide an in-vehicle communication apparatus and an in-vehicle system which can determine, in cases where there are multiple in-vehicle apparatuses each provided with a sensor and a processing device that are usable for execution of an application, an adequate combination with the in-vehicle apparatus to thereby execute the application in linkage with that in-vehicle apparatus; and to provide an application processing method by the in-vehicle communication apparatus. Since, when there are the thus-usable multiple sensors and processing devices, the adequate combination with the in-vehicle apparatus is determined, it is possible to obtain an adequate processing result. Further, when an already-existing in-vehicle apparatus and an already-existing function are utilized, it is possible to reduce the number of in-vehicle apparatuses and functions to be newly added, to thereby achieve execution of the application at low cost.

### BRIEF DESCRIPTION OF DRAWINGS

FIG. 1 is a block diagram showing a configuration of an in-vehicle communication apparatus according to Embodiment 1.

FIG. 2 is a diagram showing communication routes between the in-vehicle communication apparatus and vehicle outside apparatuses/in-vehicle apparatuses, according to Embodiment 1.

FIG. 3 is a hardware configuration diagram of a control unit in the in-vehicle communication apparatus according to Embodiment 1.

FIG. 4 is a diagram for illustrating how application profile configurations are managed by the in-vehicle communication apparatus according to Embodiment 1.

FIG. 5 is a diagram for illustrating how data received is classified by the in-vehicle communication apparatus according to Embodiment 1.

FIG. 6 is a flowchart showing processing of data received from the outside of a vehicle, by the in-vehicle communication apparatus according to Embodiment 1.

FIG. 7 is a flowchart showing processing of data to be transmitted to the outside of the vehicle, by the in-vehicle communication apparatus according to Embodiment 1.

FIG. 8 is a flowchart showing execution processing of an application by a processing unit specified by the in-vehicle communication apparatus according to Embodiment 1.

FIG. 9 is a flowchart showing output processing of a processing result of the application by an in-vehicle apparatus specified by the in-vehicle communication apparatus according to Embodiment 1.

FIG. 10 is a flowchart showing normal processing by an in-vehicle apparatus to which the in-vehicle communication apparatus according to Embodiment 1 is connected.

FIG. 11 is a diagram showing a priority management table with respect to application profiles, of the in-vehicle communication apparatus according to Embodiment 1.

FIG. 12 is a block diagram showing a configuration of an in-vehicle communication apparatus according to Embodiment 2.

FIG. 13 is a flowchart showing reception processing of an application by a mobile information terminal specified by the in-vehicle communication apparatus according to Embodiment 2.

FIG. 14 is a flowchart showing execution processing of an application by the mobile information terminal specified by the in-vehicle communication apparatus according to Embodiment 2.

FIG. 15 is a block diagram showing a configuration of an in-vehicle apparatus to which an in-vehicle communication apparatus according to Embodiment 3 is connected.

FIG. 16 is a diagram showing a situation where a mobile information terminal according to Embodiment 3 is not moving by a vehicle.

FIG. 17 is a diagram showing a situation where the mobile information terminal to which the in-vehicle communication apparatus according to Embodiment 3 is connected, is moving by the vehicle.

FIG. 18 is a flowchart showing moving state determination processing by the mobile information terminal to which the in-vehicle communication apparatus according to Embodiment 3 is connected.

### DESCRIPTION OF EMBODIMENTS

Hereinafter, in-vehicle communication apparatuses and application processing methods by the in-vehicle communication apparatuses according to embodiments of the present application will be described with reference to the drawings. It should be noted that, in the drawings, the same reference numerals are assigned to the same or equivalent components, and this commonly applies throughout the entire text of this description.

### 1. Embodiment 1

### Configuration of In-Vehicle Communication Apparatus

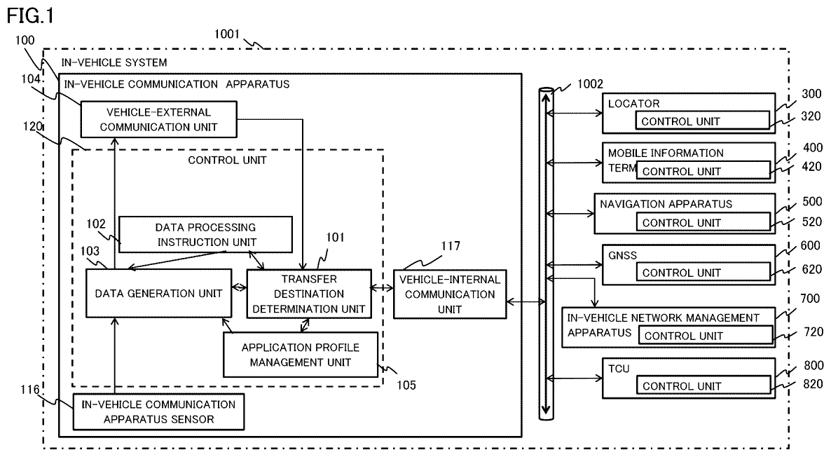

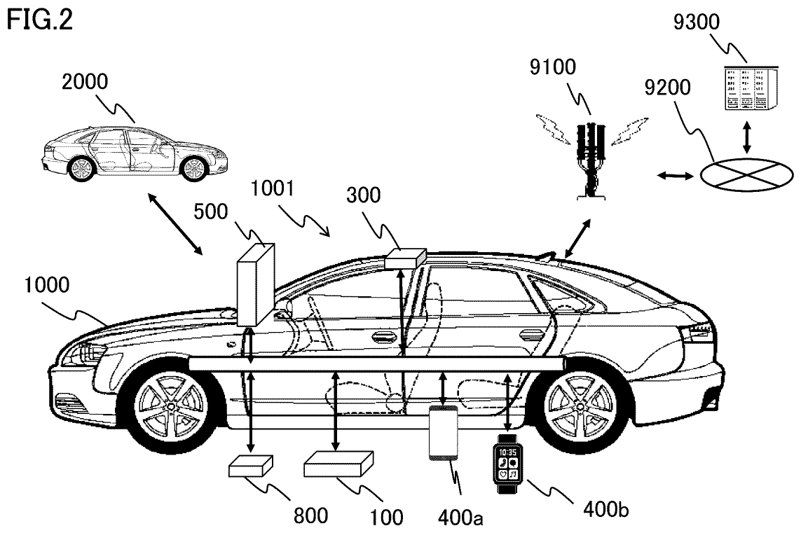

FIG. 1 is a block diagram showing a configuration example of an in-vehicle communication apparatus 100 according to Embodiment 1. FIG. 2 is a diagram showing communication routes between the in-vehicle communication apparatus 100 and vehicle outside apparatuses/in-vehicle apparatuses.

The in-vehicle communication apparatus 100 is connected, through an in-vehicle network 1002, to a locator 300, a mobile information terminal 400, a navigation apparatus 500, a GNSS 600, an in-vehicle network management apparatus 700 and a TCU (Telematics Control Unit) 800 that are in-vehicle apparatuses installed in a vehicle. These apparatuses having control units 320, 420, 520, 620, 720 and 820 as their respective processing devices, are installed as arbitrarily given apparatuses in the vehicle 1000.

The in-vehicle communication apparatus 100 may also be one in-vehicle apparatus. They constitute an in-vehicle system 1001 as a whole and are installed in the vehicle 1000. Here, the in-vehicle network management apparatus 700 is an apparatus that manages the in-vehicle network 1002 and, when a master/slave type communication system is applied thereto, it means a master device. When a CAN (Controller Area Network) (registered trademark) is applied, the management apparatus may be provided in a body control apparatus (Body-ECU) that controls the whole of the vehicle and thus be referred to as “Body-CAN”.

The TCU means an in-vehicle built-in system that connects the vehicle to a cloud service or another vehicle by use of a network of a cellular (registered trademark) system and in accordance with a V2X standard. Here, it is an apparatus that connects the in-vehicle system 1001 to a vehicle outside network (cloud service).

The in-vehicle apparatuses are not limited to those drawn in the configuration example to which devices, hardware and software indicated in FIG. 1 are connected and thus, devices, hardware and software that are installed in the vehicle 1000 may include a DMS (Driver Monitoring System), a head-up display (HUD: Head-Up Display), an instrument panel, an in-vehicle speaker and/or the like. In FIG. 2, a case is shown where a smartphone 400a and a smartwatch 4000 are connected each as an example of the mobile information terminal 400. As the mobile information terminal 400, a tablet, a wearable terminal, a virtual reality (VR: Virtual Reality) device, an augmented reality (AR: Augmented Reality) device, or the like may be used. Further, it is not required that each of the in-vehicle apparatuses be connected to the in-vehicle network 1002 by wire, and it may be connected thereto by non-contact communication, examples of which include “Bluetooth” (registered trademark), an infrared communication or the like. It is allowed that the mobile information terminal 400 owned by a passenger for the vehicle 1000, when it is brought into that vehicle, is connected automatically by Bluetooth, thereby to constitute a part of the in-vehicle system 1001 and thus to be utilized as the in-vehicle apparatus.

The in-vehicle communication apparatus 100 is connected to the vehicle outside apparatuses through a vehicle-external communication unit 104. In FIG. 2, the in-vehicle communication apparatus 100 is connected to an in-vehicle communication apparatus installed in another vehicle 2000, a roadside apparatus 9100, a server 9300 for Internet 9200 examples of which include a server on a cloud, etc., as the apparatuses outside the vehicle 1000. In addition, a vehicle-external communication unit is provided in each of the mobile information terminal, the locator, the TCU, etc., and establishes communications with the vehicle outside apparatuses.

The vehicle may be a four-wheeled vehicle, examples of which include a passenger car, a truck, a bus and the like. The vehicle may also be a two-wheeled vehicle, example of which include a motorcycle, a motorized bicycle, a three-wheeler and a bicycle. The vehicle is regarded as a moving object and is not limited to these examples.

The in-vehicle communication apparatus 100 has, other than the vehicle-external communication unit 104, a vehicle-internal communication unit 117 for making a connection to the in-vehicle network 1002, an in-vehicle communication apparatus sensor 116 and a control unit 120. Here, the control unit 120 is configured with a transfer destination determination unit 101, a data processing instruction unit 102, a data generation unit 103, and an application profile management unit 105. In the control unit 120, functions for transfer destination determination, data processing instruction, data generation and application profile management are executed.

The in-vehicle communication apparatus sensor 116 is configured with a GNSS, an acceleration sensor, a gyro sensor and the like. Further, sensors, such as a GNSS, an acceleration sensor, a gyro sensor and the like are also installed in each of the mobile information terminal 400, the locator 300, the navigation apparatus 500 and the like.

The in-vehicle network 1002 makes connections between respective apparatuses existing in the in-vehicle system 1001. As the in-vehicle network 1002, a wired network, such as a CAN (registered trademark), a LAN (Local Area Network) or the like may be used, wireless network such as a wireless LAN, Bluetooth or the like may be used. The control unit 120 is connected to other in-vehicle apparatuses through the in-vehicle network 1002, and performs data transactions with the other in-vehicle apparatuses and gives thereto instructions about their tasks to be executed.

### Hardware Configuration of Control Unit

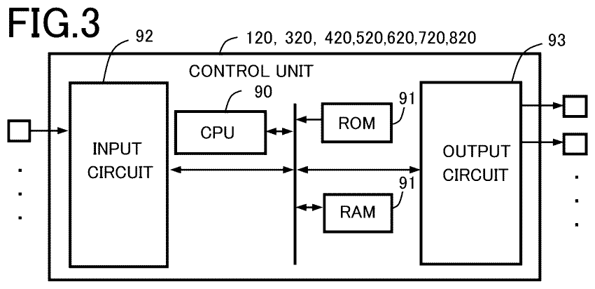

FIG. 3 is a hardware configuration diagram of the control unit 120. Although the hardware configuration diagram of FIG. 3 may be applied to each of the control units 320, 420, 520, 620, 720, 820 of the other in-vehicle apparatuses, description will be made about the control unit 120 as a representative as follows. In this Embodiment, the control unit 120 is an electronic control device for performing information processing in which information inputted from the in-vehicle communication apparatus sensor 116, the vehicle-external communication unit 104 and/or the vehicle-internal communication unit 117 in the in-vehicle communication apparatus 100 is processed and then outputted from the vehicle-external communication unit 104 and/or the vehicle-internal communication unit 117. The respective functions of the control unit 120 are implemented by a processing circuit included in the control unit 120. Specifically, the control unit 120 includes as the processing circuit: an arithmetic processing device 90 (computer) such as a CPU (Central Processing Unit) or the like; storage devices 91 that perform data transactions with the arithmetic processing device 90; an input circuit 92 that inputs external signals to the arithmetic processing device 90; an output circuit 93 that externally outputs signals from the arithmetic processing device 90; and the like.

As the arithmetic processing device 90, there may be included an ASIC (Application Specific Integrated Circuit), an IC (Integrated Circuit), a DSP (Digital Signal Processor), an FPGA (Field Programmable Gate Array), any one of a variety of logic circuits, any one of a variety of signal processing circuits, or the like. Further, multiple arithmetic processing devices 90 of the same type or different types may be included so that the respective parts of processing are executed in a shared manner. As the storage devices 91, there are included a RAM (Random Access Memory) that is configured to allow reading and writing of data by the arithmetic processing device 90, a ROM (Read Only Memory) that is configured to allow reading of data by the arithmetic processing device 90, and the like. As the storage device 91, a non-volatile or volatile semiconductor memory, such as a flash memory, an EPROM, an EEPROM or the like, may be used. In order to input information from the in-vehicle communication apparatus sensor 116, the vehicle-external communication unit 104 and the vehicle-internal communication unit 117, the input circuit 92 includes A-D converters, a communication circuit, etc. to which a variety of sensors and switches and communication lines including an output signal line of the in-vehicle communication apparatus sensor 116, are connected, and which serve to input the output signals of the sensors and switches, and communication information, to the arithmetic processing device 90. The output circuit 93 includes a driver circuit, a communication circuit, etc. which serve to output control signals coming from the arithmetic processing device 90 to various devices including the vehicle-external communication unit 104 and the vehicle-internal communication unit 117.

The respective functions that the control unit 120 includes, are implemented in such a manner that the arithmetic processing device 90 executes software (programs) stored in the storage device 91 such as the ROM or the like, to thereby cooperate with the other hardware in the control unit 120, such as the other storage device 91, the input circuit 92, the output circuit 93, etc. Although each of the functions may be established by a software module, it may be established by a combination of software and hardware.

### Vehicle-External Communication Unit

The vehicle-external communication unit 104 is a device which includes: a receiver that receives data from a moving object placed around the vehicle 1000; and a transmitter that transmits data. Specifically, the vehicle-external communication unit 104 may utilize a cellular network (registered trademark) of LTE (Long Term Evolution) (registered trademark), fifth generation mobile communication system (5G) or the like, or a communication system of DSRC (Dedicated Short Range Communication), Cellular-V2X or the like dedicated to vehicle communication.

“DSRC” is a unidirectional or bidirectional wireless communication technology that was designed focusing on wireless communications with vehicles and that uses an ISM band (Industrial Scientific and Medical Band) of 5.8 GHz, which may be referred to also as Dedicated Narrow-Band Communication or Narrow-Band Communication. “Cellular-V2X”, which is disclosed in 3GPP (Third Generation Partnership Project) (registered trademark) as Third Generation Mobile Communication System Standard, is a standard for performing V2X (Vehicle to Everything) communication by using a wireless communication line for mobile telephones. “5GAA” (Five Generation Automotive Association) that is a global industry transverse organization, recommends incorporating that standard.

The in-vehicle communication apparatus 100, when it establishes direct communications with vehicles around the vehicle 1000, can achieve advanced driving Safety support and advanced automated driving, and can acquire information of the vehicles therearound, traffic information, entertainment information, etc. by making connection to a server with a cloud. When the vehicle establishes communication with the vehicle therearound or the roadside apparatus, it may use, other than the vehicle-external communication unit 104, any one of device communication functions such as a TCU communication function, a communication function of the smartphone, a communication function that the other in-vehicle apparatus has, or the like.

In FIG. 1, only one control unit 120 and only one vehicle-external communication unit 104 are shown. However, multiple control units 120 and/or multiple vehicle-external communication units 104 may be provided, and the multiple control units 120 may execute the programs that implement the respective functions, in a cooperative manner. With respect to the multiple vehicle-external communication units 104, the vehicle-external communication unit 104 that is subject to transmission/reception may be changed according to the type of data.

### Function of Control Unit

On the basis of information informed by the application profile management unit 105, the transfer destination determination unit 101 determines a delivery destination of data received from the vehicle-external communication unit 104 or the vehicle-internal communication unit 117. The transfer destination determination unit 101 delivers the received data to the thus-determined route/apparatus.

For example, when the received data is to be processed by the data processing instruction unit 102, the transfer destination determination unit 101 transfers the received data to the data processing instruction unit 102, and when the received data is to be processed by the mobile information terminal 400, the transfer destination determination unit 101 transfers the received data to the mobile information terminal 400.

The data processing instruction unit 102 evaluates, using the data thus received, the necessity of vehicle control or support/advice for the driver, to thereby determine how automated driving is controlled, whether or not driving support is necessary, or how is the risk of collision. In order to execute such determination, a driving support determination unit 118 may be specially provided.

Further, the data processing instruction unit 102, when having determined that the support is necessary, transmits the content of support to the in-vehicle apparatus capable of displaying and/or uttering that content. When, for example, there is no displayable/utterable device in the in-vehicle communication apparatus 100, the mobile information terminal 400 is informed of the content of support through the transfer destination determination unit 101, to thereby achieve displaying/uttering that content.

Although the in-vehicle communication apparatus 100 according to Embodiment 1 shows a case where no displaying/uttering device is installed therein, a displaying/uttering device may be installed in the in-vehicle communication apparatus 100 to establish the in-vehicle system 1001.

It is allowed that the data generation unit 103 receives data of the in-vehicle communication apparatus sensor 116 and receives data of the in-vehicle apparatus installed in the vehicle 1000 or a sensor of that in-vehicle apparatus from the transfer destination determination unit 101, to thereby generate transmission data and externally transmit it through the in-vehicle communication apparatus 100. The data generation unit 103, when having received plural pieces of sensor information or plural processing results according to an application, selects data to be used on the basis of information informed by the application profile management unit 105, to generate transmission data.

### Application Profile Management Unit

The application profile management unit 105 manages applications (services) which can be provided by the in-vehicle system 1001, and informs the data generation unit 103 and the transfer destination determination unit 101 about application profile information which includes: information of sensors to be used according to the application provided by the in-vehicle system 1001; and information of devices that actualize functions required for the in-vehicle apparatuses.

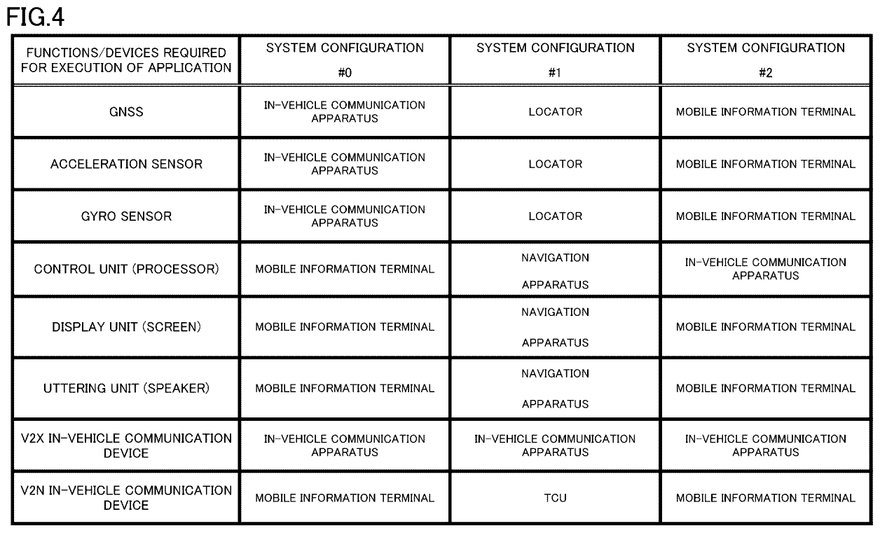

For example, the application profile management unit 105 manages, as the applications which can be provided by the in-vehicle system 1001, an automated driving application, a driving safety support application, an application for providing traffic information, an application for entertainment, and the like. Further, as is shown, for example, in FIG. 4, the application profile management unit 105 manages information about functions required for generating data of the driving safety support application and about combinations of in-vehicle apparatuses having devices that actualize these functions.

### Application Profile Configuration Management

Using FIG. 4, an example of how the in-vehicle communication apparatus 100 according to Embodiment 1 manages the application profile configuration, will be described. In FIG. 4, “GNSS (Positioning Function)”, “Acceleration Sensor”, “Gyro Sensor”, “Control Unit (Processor)”, “Display Unit (Screen)”, “Uttering Unit (Speaker) ”, “V2X In-vehicle Communication Device” and “V2N In-vehicle Communication Device” are shown as exemplary functions/devices that are required for generating data of the driving safety support application, and exemplary system configurations are shown each representing which device is used for actualizing each of the functions/devices.

For example, “System Configuration #0” in FIG. 4 shows a case where the system is established using the in-vehicle communication apparatus 100 and the mobile information terminal 400. “System Configuration #1 shows a case where the system is established using the locator 300, the navigation apparatus 500, the in-vehicle communication apparatus 100 and the TCU 800. In the case of “System Configuration #3”, the system is configured with the mobile information terminal 400 and the in-vehicle communication apparatus 100; however, since the mobile information terminal 400 is used for actualizing “Positioning”, “Acceleration Sensor”, “Gyro Sensor”, etc. it is a case where the system is established according to a combination different from that of “System Configuration #0”.

In FIG. 4, as examples in order to actualize “GNSS (Positioning Function)”, there are shown, according to “System Configuration #0”, a case where the in-vehicle communication apparatus sensor 116 of the in-vehicle communication apparatus 100 is used; according to “System Configuration #1”, a case where the locator 300 is used; and according to “System Configuration #2”, a case where the mobile information terminal 400 is used. Each in-vehicle apparatus selected in the application profile configuration is that having been selected on the basis of the type of sensor, the accuracy of sensor, the reliability of sensor output, the processing performance (processing load) of the control unit, the congestion degree of communication, or the like.

For example, when the locator 300, the navigation apparatus 500 and the TCU 800 are not installed in the vehicle 1000 that is going to execute the driving safety support application, the application has to be executed using the in-vehicle communication apparatus 100 and the mobile information terminal 400, So that “System Configuration #0” or “System Configuration #2” is selected.

In this case, as shown in “System Configuration #2”, the control unit 120 in the in-vehicle communication apparatus 100 may be used as “Control Unit (Processor)”. However, as represented by the case where there is a need for the in-vehicle communication apparatus 100 to execute the automated driving application, such cases are conceivable where the automated driving application is desired to be executed with a reduced margin of load by reducing the processing load factor of the control unit 120 in the in-vehicle communication apparatus 100. In such a case, it is desired that the software of the driving safety support application be executed using the mobile information terminal 400. In that case. “System Configuration #0” is selected.

Further, when there is a specific reason such that any additional execution of application is difficult because of a high processing load factor of the control unit 420 in the mobile information terminal 400, “System Configuration #2” is selected.

Such a case is further conceivable where the mobile information terminal 400 is not connected to the in-vehicle system 1001 of the vehicle 1000. In that case, it is thought that any necessary function may be covered by the in-vehicle communication apparatus 100.

Further, in the case where each of the functions/devices required for the application can be provided by multiple in-vehicle apparatuses, such an in-vehicle apparatus may be selected that is highest in accuracy with respect to the output information of its sensor. The reason is that this also makes higher the accuracy of processing according to the application.

Instead, focusing not on the accuracy of the output information of the sensor but on the reliability thereof, such an in-vehicle apparatus may be selected that is highest in the reliability. The reason is that this also makes higher the reliability of processing according to the application.

On the other hand. such a combination of in-vehicle apparatuses may be selected that minimizes the maximum value of processing load factors of the control units in all of the in-vehicle apparatuses. The reason is that this increases, at the processing according to the application, the margin of processing load with respect to the control units in the in-vehicle system 1001 as a whole.

### Priorities of In-Vehicle Apparatus for Respective Functions

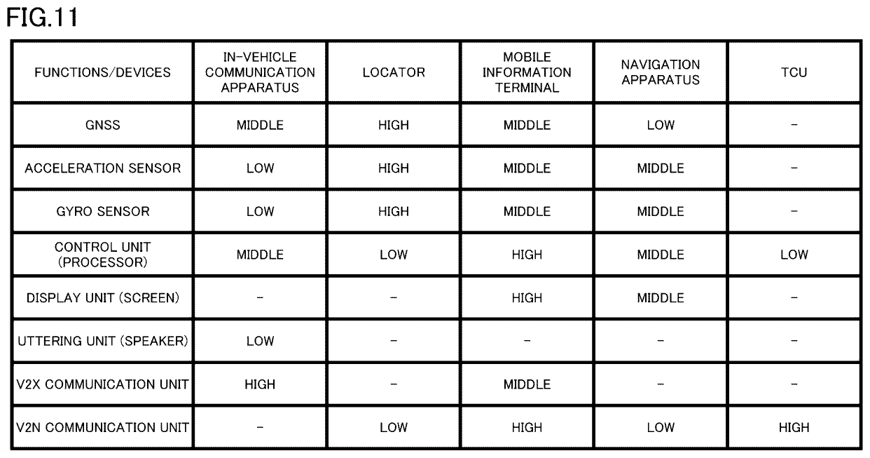

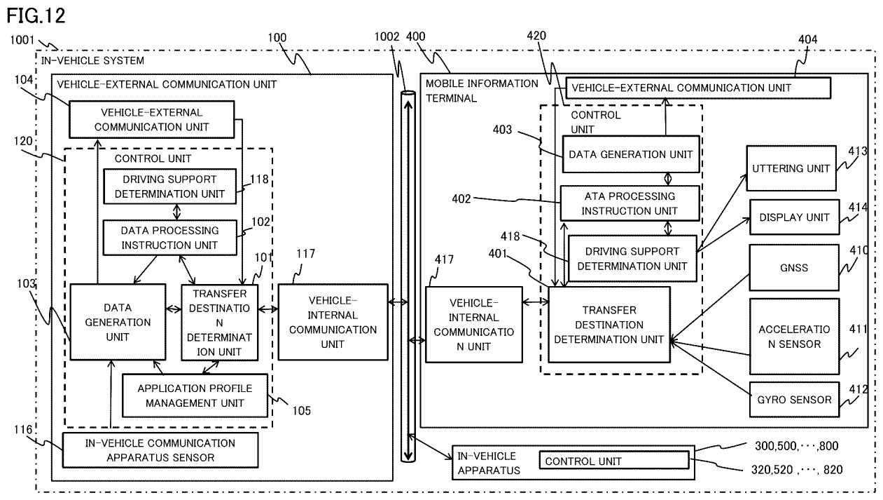

FIG. 11 is a diagram showing an example of a priority management table with respect to application profiles, of the in-vehicle communication apparatus 100 according to Embodiment 1. In FIG. 11, a case is shown where, for respective required functions/devices, priorities of each usable in-vehicle apparatus are evaluated to be “High”, “Middle” and “Low”. As an example, there are shown such priorities that suggest which devices are to be used in order to actualize “GNSS (Positioning Function)”, “Acceleration Sensor”, “Gyro Sensor”, “Control Unit (Processor)”, “Display Unit (Screen)”, “Uttering Unit (Speaker)”, “V2X In-vehicle Communication Device” and “V2N In-vehicle Communication Device” that are required for generating data of the driving safety support application.

The application profile management unit 105 can determine, for every configuration candidate of application profile, an adequate combination of in-vehicle apparatuses while taking into account orders of priorities. Specifically, while assigning scores depending on the orders of priorities, such as, score 3 for “High”, score 2 for “Middle” and score 1 for “Low”, the determination may be made according to the total score of functions/devices corresponding to the configuration candidate.

For example, a case is shown where, with respect to the priority for “Control Unit (Processor)” in the column of “Functions/Devices”, the mobile information terminal 400 is highest, followed by the navigation apparatus 500 and the in-vehicle communication apparatus 100, and then the locator 300 and the TCU 800 are ordered. This means that, with respect to the processing priority of the application, the mobile information terminal 400 is controlled to mainly perform processing and, when the processing load of the mobile information terminal 400 gets heavy, the navigation apparatus 500 or the in-vehicle communication apparatus 100 having the next highest priority is prioritized to perform processing.

Further, in a situation where the data of application software is transferred, the transfer destination determination unit 101 may transmit the corresponding received data to apparatus whose control unit (processor) is high in priority. It may transfer the data, when the processing load of the control unit in the high priority device is heavy, to a device that is next high in priority, to thereby achieve distribution of the processing load.

In the foregoing description, such a case has been described where the driving safety support application is executed and the processing result is outputted to “Display Unit (Screen)” and “Uttering Unit (Speaker)”. However, the processing result may be transmitted to a vehicle outside apparatus through the vehicle-external communication unit 104.

Description will be made about a case where the application profile management unit 105 determines the system configuration. The application profile management unit 105 transfers the application profile information that indicates a combination of apparatuses assigned to the respective functions/devices, to the data generation unit 103 and the transfer destination determination unit 101. The vehicle-internal communication unit 117 transmits that information to in-vehicle apparatuses specified by the transfer destination determination unit 101.

The in-vehicle communication apparatus 100 may transmit data informed by the data generation unit 103, to a vehicle outside apparatus through the vehicle-external communication unit 104. As a communication system in this case, the aforementioned DSRC or C-V2X may be used. The vehicle-external communication unit 104 receives information from the in-vehicle communication apparatus of the vehicle 2000 placed outside the vehicle 1000, the outside roadside apparatus 9100 and/or every kind of apparatus placed around the vehicle 1000, and informs the vehicle-external communication unit 104 about that information.

### Priority of Received Data

FIG. 5 is a diagram for illustrating how data received is classified by the in-vehicle communication apparatus 100 according to Embodiment 1. The data received from the vehicle-external communication unit 104 is composed of: a type indicating that it is application data or sensor information; a priority indicating one of “Priority 1”, “Priority 2” and “Priority 3”; and the main body of the received data. The application data and the sensor information that are high in priority are preferentially transferred to the in-vehicle apparatus that needs them.

### Reception Processing

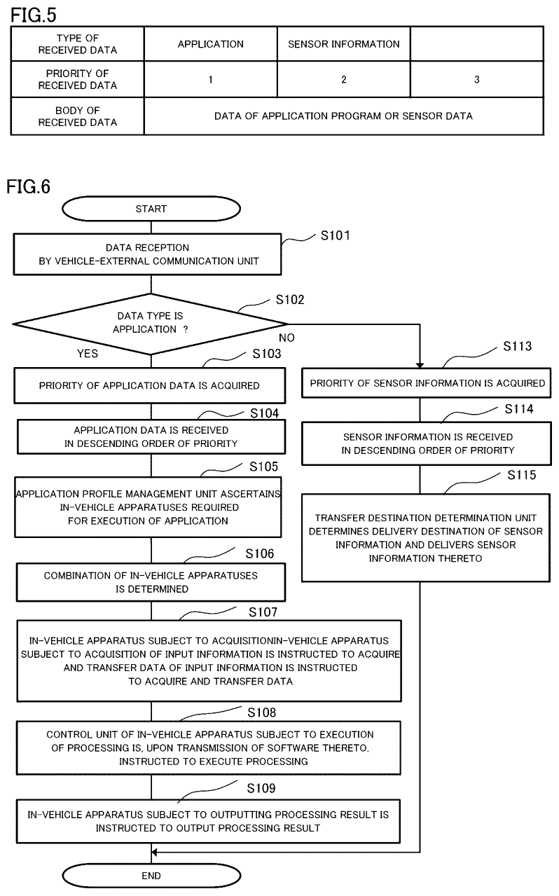

FIG. 6 is a flowchart showing processing of data received from the outside of the vehicle, by the in-vehicle communication apparatus 100 according to Embodiment 1. The processing shown in FIG. 6 may be started every time the vehicle-external communication unit 104 receives the data. Instead, the processing may be executed every fixed period of time (for example, 1 ms) and terminated if there is no received data in that period.

Operations of the in-vehicle communication apparatus 100 according to Embodiment 1 correspond to the processing by the program of the in-vehicle communication apparatus. Upon starting the processing, data received in Step S101 by the vehicle-external communication unit 104 is sent to the transfer destination determination unit 101. Upon receiving that data, the transfer destination determination unit 101 determines the type of data. In Step S102, whether the type of the received data is application data or not is determined. If it is application data (Judgement is YES), the flow moves to Step S103. If the type is not application data (judgement is NO), namely, in the case where the type is sensor information, the flow moves to Step S113.

In Step S103, the transfer destination determination unit 101 acquires the priority of the received data. In Step S104, if there are multiple pieces of application data as the received data, in the order of priority, each piece of application data is received and brought to the following processing.

In Step S105, the application profile management unit 105 acquires information about functions/devices that are required for the processing to be executed by the application. Specifically, it ascertains usable in-vehicle apparatuses connected to in the in-vehicle system 1001. Then, it makes up candidates for the combination of apparatuses to be required.

In Step S106, the most adequate combination of apparatuses is determined on the basis of a prescribed criterion. The data generation unit 103 and the transfer destination determination unit 101 are informed of such application profile information.

Then, in Step S107, depending on the service provided by the application, the application profile management unit 105 informs the data generation unit 103 and the transfer destination determination unit 101 about the application profile information including the information of sensors to be used. Then, the supplication profile information is transmitted through the vehicle-internal communication unit 117, and the data processing instruction unit 102 instructs the in-vehicle apparatus that is subject to acquisition of input information required for executing processing according to the application, to acquire and transfer the corresponding data.

In Step S108, the application profile management unit 105 specifies the control device to which the software data of the application is to be transferred, and transfers that data thereto through the transfer destination determination unit 101 by using the vehicle-internal communication unit 117. Then, the data processing instruction unit 102 instructs the control device to execute processing according to the application. Specifically, when the input information required for the processing according to the application is received, the control unit of the corresponding in-vehicle apparatus executes the processing and transfers the processing result.

In Step S109, depending on the service provided by the application, the application profile management unit 105 informs the data generation unit 103 and the transfer destination determination unit 101 about the application profile information including the in-vehicle apparatus that is subject to outputting the processing result. Then, the supplication profile information is transmitted through the vehicle-internal communication unit 117, and the data processing instruction unit 102 instructs the in-vehicle apparatus that is to execute outputting after the processing according to the application, to output the processing result.

Specifically, when the processing result of the application is transferred, the control unit of the corresponding in-vehicle apparatus executes processing and outputs the processing result to “Display Unit (Screen)”, “Uttering Unit (Speaker)”, etc. Thereafter, the processing is terminated.

In Step S113, the transfer destination determination unit 101 acquires the priority of the received data. In Step S114, if there are multiple pieces of sensor information as the received data, in the order of priority, each piece of sensor information is received and brought to the following processing.

In Step S115, the transfer destination determination unit 101 determines the delivery destination of the received data on the basis of the application profile information informed by the application profile management unit 105. The transfer destination determination unit 101 delivers the received data to the in-vehicle apparatus by way of a route corresponding to that determination. Thereafter, the processing is terminated.

Here, description will made about an application processing method by the in-vehicle communication apparatus 100 according to Embodiment 1. Step S105 and Step S106 in FIG. 6 correspond to an application execution allocation determination step in which the application profile management unit 105 determines a combination of in-vehicle apparatuses that are required, respectively, for acquiring and transferring input information that is needed for execution of the application, for executing processing according to the application on the basis of the transferred input information, and for outputting the processing result of the thus-executed application. Further, Step S107 to Step S109 in FIG. 6 correspond to an application execution instruction step in which the data processing instruction unit 102 instructs the in-vehicle apparatuses of said combination determined by the application profile management unit 105, to acquire and transfer the input information, to execute the processing on the basis of the transferred input information, and to output the processing result of the executed processing.

### Transmission Processing

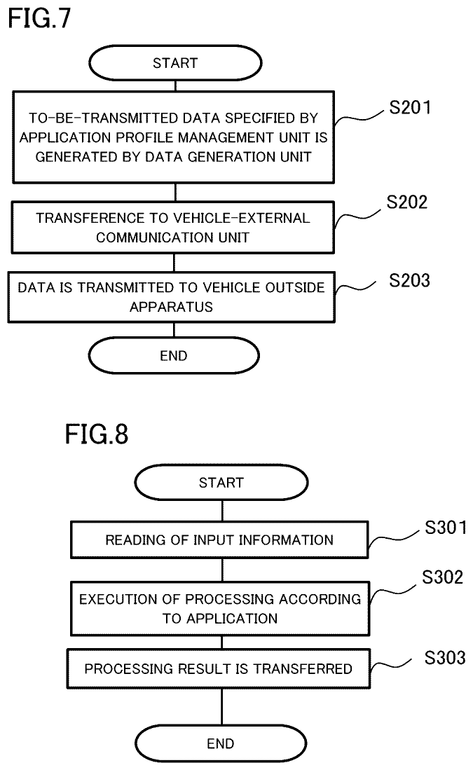

FIG. 7 is a flowchart showing processing of data to be transmitted to the outside of the vehicle, by the in-vehicle communication apparatus 100 according to Embodiment 1. The processing shown in FIG. 7 may be started every time the vehicle-external communication unit 104 is to transmit the data. Instead, the processing may be executed every fixed period of time (for example, 1 ms) and terminated if there is generated no to-be-transmitted data in that period. Here, such a case is assumed where, in the application profile, it is stipulated by the application profile management unit 105 that the processed output of the thus-executed application is transmitted to a vehicle outside apparatus through the vehicle-external communication unit 104.

Upon starting the processing, in Step S201, the data generation unit 103 generates from the transferred processing result, data to be transmitted by the data generation unit 103, on the basis of the application profile information informed by the application profile management unit 105.

In Step S202, the data generated by the data generation unit 103 is transferred to the vehicle-external communication unit 104. Then, in Step S203, the vehicle-external communication unit 104 transmits the thus-transferred data to the outside of the vehicle, so that the processing is terminated.

### Execution Processing of Application

FIG. 8 is a flowchart showing execution processing of an application by a processing unit specified by the in-vehicle communication apparatus 100 according to Embodiment 1. The processing shown in FIG. 8 represents how the in-vehicle apparatus instructed by the data processing instruction unit 102 processes the execution of the application. This is processing that the processing unit in the in-vehicle apparatus executes after the input information is transferred thereto. The processing may be started in response to the fact that the input information has been transferred thereto, as a trigger. Instead, the processing may be executed every fixed period of time (for example, 1 ms) and terminated if there appears no transferred input information in that period.

Upon starting the processing, in Step S301, the in-vehicle apparatus reads the thus-transferred input information. Then, in Step S302, the application is executed by the control unit of the in-vehicle apparatus.

In Step S303, the control unit of the in-vehicle apparatus transmits the processing result to the in-vehicle network 1002. Accordingly, the processing result is transferred to an in-vehicle apparatus for outputting that result. Thereafter, the processing is terminated.

### Output of Processing Result

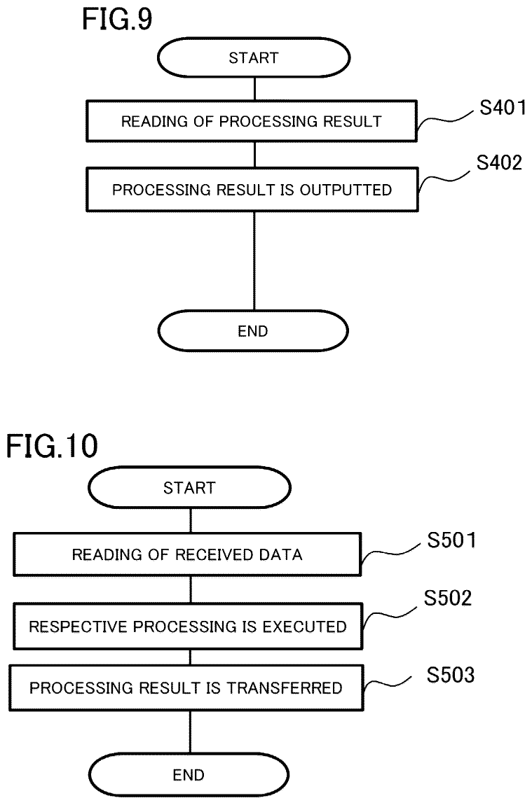

FIG. 9 is a flowchart showing output processing of a processing result of the application by an in-vehicle apparatus specified by the in-vehicle communication apparatus 100 according to Embodiment 1. The processing shown in FIG. 9 represents how the in-vehicle apparatus instructed by the data processing instruction unit 102 outputs the processing result of the application. This is processing that the processing unit in the in-vehicle apparatus executes after the processing result is transferred thereto. The processing may be started in response to the fact that the processing result has been transferred thereto, as a trigger. Instead, the processing may be executed every fixed period of time (for example, 1 ms) and terminated if there appears no transferred processing result in that period.

Upon starting the processing, in Step S401, the in-vehicle apparatus reads the thus-transferred processing result. Then, in Step S402, the in-vehicle apparatus outputs it by using “Display Unit (Screen), “Uttering Unit (Speaker) and/or the like. Thereafter, the processing is terminated.

### Normal Processing by In-Vehicle Apparatus

FIG. 10 is a flowchart showing normal processing by an in-vehicle apparatus to which the in-vehicle communication apparatus 100 according to Embodiment 1 is connected. The respective in-vehicle apparatuses connected to in the in-vehicle system 1001 execute their normal processing, other than the processing based on the instructions with respect to acquisition of the input information related to an application from the in-vehicle communication apparatus 100, transference of the input information, execution of the processing, transference of the processing result and outputting of the processing result. FIG. 10 is a flowchart showing an exemplified flowchart about the normal processing. The processing may be executed every time the data required for that processing is transferred.

Upon starting the processing, in Step S501, the in-vehicle apparatus reads the received data transferred thereto. Then, in Step S502, the in-vehicle apparatus executes its normal processing on the basis of the received data. Then, in Step S503, it transfers the processing result by using the in-vehicle network 1002. Thereafter, the processing is terminated.

The in-vehicle communication apparatus 100 according to Embodiment 1 has been described as being configured to take part in the execution of the application together with the other in-vehicle apparatuses installed in the vehicle 1000 and connected to in the in-vehicle system 1001. However, the in-vehicle communication apparatus 100 may be configured not to cause the in-vehicle communication apparatus sensor to deliver its acquired information and not to cause the control unit 120 of the in-vehicle communication apparatus 100 to contribute to the execution of the application as a processing device, but to use the other in-vehicle apparatus(s) to take over such operations.

Note that the in-vehicle system 1001 according to Embodiment 1 represents a case where the functions/devices are classified to sensors, a communication and control units, display and uttering units, etc., and the in-vehicle apparatuses to be used are selected correspondingly. However, the range of classification may be finer than the above. Further, plural functions or devices may be managed as a group.

As described above, in the case where multiple in-vehicle apparatuses and multiple functions/devices included in these in-vehicle apparatuses are installed in the in-vehicle system 1001, the in-vehicle communication apparatus 100 according to Embodiment 1 can determine the application profile configuration by comparison using the accuracy of sensor or the reliability of sensor that the application requires, the processing load factor of the control unit or the priority of the in-vehicle apparatus for use. Since the sensor information to be used can be selected, it is possible to generate data that is adequate for the service.

Further, when an already-existing in-vehicle apparatus or an already existing device/function in the in-vehicle system 1001 is utilized, it is possible to minimize the number of devices/functions to be newly added, to thereby establish the system at low cost. Further, when the mobile information terminal 400 owned by a passenger is utilized to execute the application, it is possible to establish the system at low cost.

Furthermore, according to such an in-vehicle communication apparatus 100, when the processing load of the control unit as a high priority function/device is heavy, the device that is next high in priority is called on to act instead, so that it is possible to achieve distribution of the processing load.

### 2. Embodiment 2

### Configurations of In-Vehicle Communication Apparatus and Mobile Information Terminal

FIG. 12 is a block diagram showing a configuration of an in-vehicle communication apparatus 100 according to Embodiment 2. In the in-vehicle communication apparatus 100 according to Embodiment 2, with respect to the same parts as those in Embodiment 1, the same reference numerals are assigned thereto and duplicated detailed description thereof will be omitted.

FIG. 12 of Embodiment 2 differs from the figure of Embodiment 1 in that the detailed configuration of a mobile information terminal 400 is drawn. Description will be made on the assumption that a driving safety support application is executed as an application content. In accordance therewith, driving support determination units 118, 418 that determine whether or not driving safety support is necessary, are provided as special units in a control unit 120 of the in-vehicle communication apparatus 100 and a control unit 120 of the mobile information terminal 400, respectively, and this differs from Embodiment 1.

In Embodiment 2, as shown additionally in FIG. 12, the mobile information terminal 400 includes a control unit 420, a vehicle-external communication unit 404, a vehicle-internal communication unit 417, a GNSS 410, an acceleration sensor 411, a gyro sensor 412, an uttering unit 413 and a display unit 414. Further, the control unit 420 is configured with a transfer destination determination unit 401, a data processing instruction unit 402, a data generation unit 403 and the driving support determination unit 418.

### Reception Processing of Application

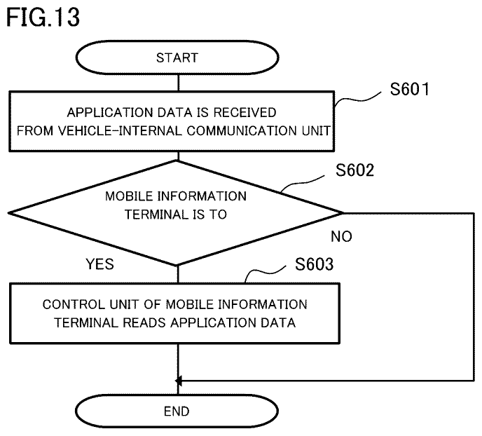

In Embodiment 2, processing by the mobile information terminal 400 will be described. FIG. 13 is a flowchart showing reception processing of an application by the mobile information terminal 400 specified by the in-vehicle communication apparatus 100 according to Embodiment 2.

FIG. 13 represents processing to be started when the mobile information terminal 400 receives application data from the in-vehicle network 1002. Upon starting the processing, in Step S601, the control unit 420 receives the application data from the in-vehicle network 1002 through the vehicle-internal communication unit 417 of the mobile information terminal 400.

Then, in Step S602, the transfer destination determination unit 401 determines, on the basis of the application profile information, whether the mobile information terminal 400 is to execute processing according to the application or another in-vehicle apparatus is to execute processing according to the application. If the mobile information terminal 400 is to execute the processing (judgement is YES), the flow moves to Step S603. If the mobile information terminal 400 is not to execute the processing (judgement is NO), the processing is terminated without any further operation.

In Step S603, the control unit 420 of the mobile information terminal 400 reads the application data. Thereafter, the processing is terminated.

### Execution Processing of Application

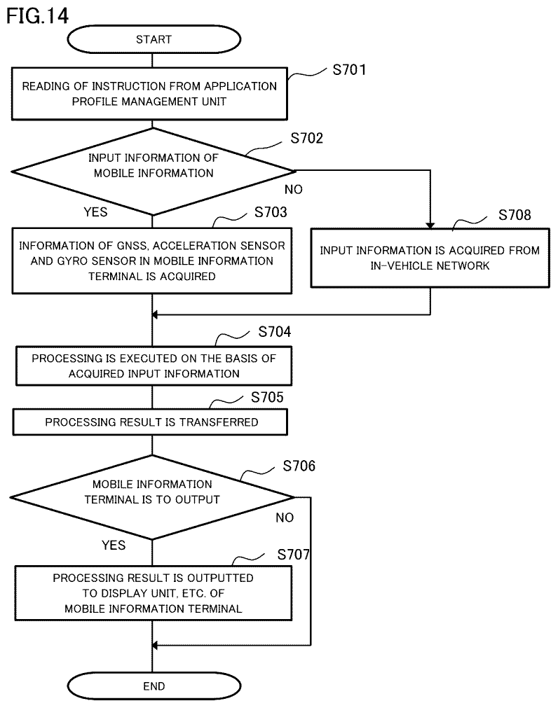

FIG. 14 is a flowchart showing execution processing of an application by the mobile information terminal 400 specified by the in-vehicle communication apparatus 100 according to Embodiment 2. FIG. 14 represents processing to be started by the mobile information terminal 400 when it received the application data from the in-vehicle network 1002 and then completed reading thereof.

Upon starting the processing, in Step S701, on the basis of the application profile information informed by the application profile management unit 105, the control unit 420 of the mobile information terminal 400 reads an instruction about input information that is required at the time of the execution of the application. It determines whether or not information inputted from sensors held in the mobile information terminal 400 is to be used as the input information.

If the input information of the mobile information terminal 400 is to be used (judgement is YES), the flow moves to Step S703. In Step S703, information of the GNSS 410, the acceleration sensor 411 and the gyro sensor 412 of the mobile information terminal 400 is acquired as the input information. Then, the flow moves to Step S704.

If, in Step S702, the input information of the mobile information terminal 400 is determined not to be used (judgement is NO), the flow moves to Step S708. In Step S708, after waiting for input information transferred from the other in-vehicle apparatus through the in-vehicle network 1002, the control unit acquires that input information. Then, the flow moves to Step S704.

In Step S704, the control unit 420 of the mobile information terminal 400 executes processing according to the application. Then, in Step S705, it transfers the processing result through the in-vehicle network 1002.

In Step S706, it determines on the basis of the application profile information, whether or not the mobile information terminal 400 is what outputs the processing result. If the mobile information terminal 400 is what outputs the processing result (judgement is YES), the flow moves to Step S707. Here, the processing result is outputted to the display unit 414 and the uttering unit 413 of the mobile information terminal 400. Thereafter, the processing is terminated.

If, in Step S706, it is determined that the mobile information terminal 400 is not what outputs the processing result (judgement is NO), the processing is terminated without any further operation. The processing result of the application was transferred through the in-vehicle network 1002, so that the in-vehicle apparatus instructed to output the processing result executes outputting the processing result.

Here, the description has been made about the processing by the in-vehicle communication apparatus 100 and the mobile information terminal 400 according to Embodiment 2. Processing according to the application may be executed similarly by the other in-vehicle apparatus such as the locator 300, the TCU 800 or the like.

As described above, according to the in-vehicle system 1001 using the in-vehicle communication apparatus 100 as set forth in Embodiment 2, it is possible to establish the in-vehicle system 1001 by utilizing functions of the mobile information terminal 400 independently of the in-vehicle communication apparatus 100. Thus, it is possible to minimize the number of devices/functions to be newly added, to thereby establish the in-vehicle system 1001 at low cost, and thus the application can be executed adequately.

### 3. Embodiment 3

### Configurations of In-Vehicle Communication Apparatus and Mobile Information Terminal

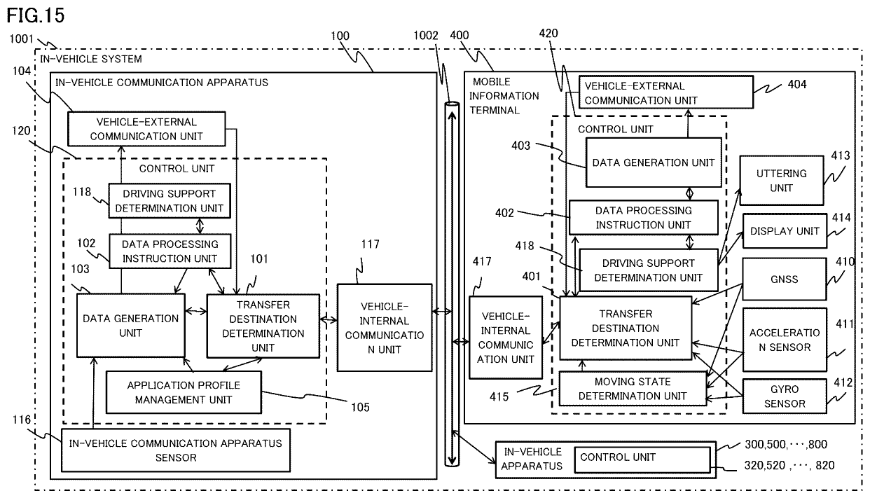

FIG. 15 is a block diagram showing a configuration of a mobile information terminal 400 connected to an in-vehicle communication apparatus 100 according to Embodiment 3. In the in-vehicle communication apparatus 100 and an in-vehicle system 1001 according to Embodiment 3, with respect to the same parts as those in Embodiment 1 and Embodiment 2, the same reference numerals are assigned thereto and duplicated detailed description thereof will be omitted.

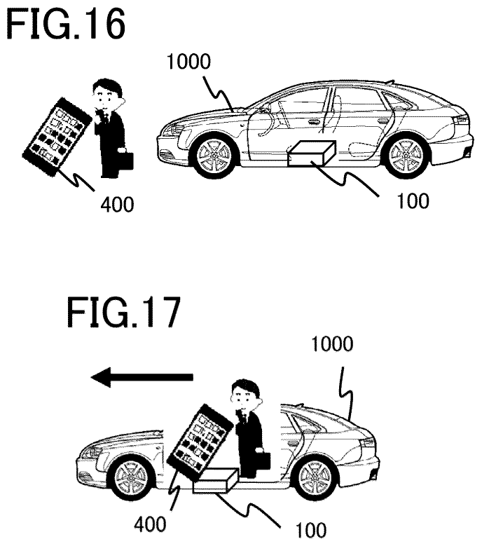

Embodiment 3 differs from Embodiment 2 in that a moving state determination unit 415 is further included in the mobile information terminal 400. FIG. 16 is a diagram showing situation where the mobile information terminal 400 according to Embodiment 3 is not moving by a vehicle 1000. FIG. 17 is a diagram showing a situation where the mobile information terminal 400 connected to the in-vehicle communication apparatus 100 according to Embodiment 3 is moving by the vehicle 1000.

In FIG. 16, a case is shown where the user who carries the mobile information terminal 400 doesn't get on the vehicle. In such a case, as usual, the mobile information terminal 400 and the in-vehicle communication apparatus 100 transmit their respective position information and movement information to thereby mutually recognize their presence.

In FIG. 17, a case is shown where the user who carries the mobile information terminal 400 gets on the vehicle 1000. In this case, the mobile information terminal 400 is connected to the in-vehicle network 1002 and connected also to the in-vehicle communication unit 100. In such a case, the mobile information terminal 400 is prevented from transmitting the position information and movement information. This is because it suffices that the transmission of position information and movement information about the vehicle 1000 is executed by the in-vehicle communication apparatus 100 as a representative. Only the in-vehicle communication unit 100 periodically transmits information such as the position information, the movement information and the like.

Accordingly, in the case of performing driving support, the mobile information terminal 400 of the user getting on the vehicle can be prevented from causing unwanted data delivery, so that it is possible to avoid communication network congestion. Further, it is possible to reduce the processing load of the control unit in each of the in-vehicle apparatuses.

### Moving State Determination Processing

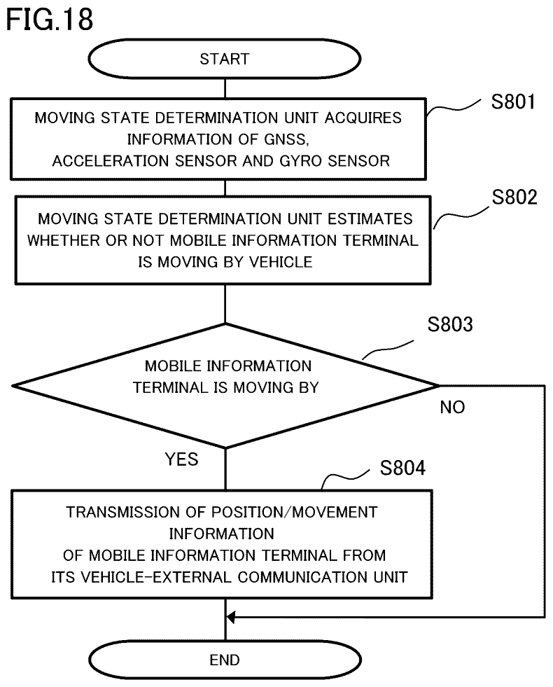

FIG. 18 is a flowchart showing moving state determination processing by the mobile information terminal 400 connected to the in-vehicle communication apparatus 100 according to Embodiment 3. The control unit 420 of the mobile information terminal 400 may execute the flowchart of FIG. 18 every fixed period of time (for example, 1 ms). Instead, it is allowed that the flowchart is not executed every fixed period of time but executed in response to a specified event, for example, at every execution of communication.

Upon starting the processing, in Step S801, the moving state determination unit 415 of the in-vehicle communication apparatus 100 acquires the information of the GNSS 410, the acceleration sensor 411 and the gyro sensor 412 in the mobile information terminal 400. Then, in Step S802, the moving state determination unit 415 estimates whether or not the mobile information terminal 400 is moving by the vehicle 1000. With respect the estimation method, estimation may be determined according to a moving state depending on the speed, or a variation in value of the acceleration sensor/the gyro sensor; however, this is not limitative.

In Step S803, the moving state determination unit 415 determines whether or not the mobile information terminal 400 is moving by the vehicle 1000. If it is determined that the mobile information terminal is moving by the vehicle 1000 (judgement is YES), the flow moves to Step S804. If it is determined that the mobile information terminal is not moving by the vehicle 1000 (judgement is NO), the processing is terminated.

In Step S804, the mobile information terminal 400 prohibits transmission of the position information/movement information from its vehicle-external communication unit 404. Further, at this time, the moving state determination unit 415 may transfer information indicating that the mobile information terminal 400 is moving together with the vehicle 1000, through the in-vehicle network 1002. After the moving state is once determined, the determination step may be skipped during a specified period of time.

It is noted that, although the in-vehicle system 1001 according to Embodiment 3 shows a case where the mobile information terminal 400 prevents its communication, the in-vehicle communication apparatus 100 may prevent such communication. Further, not only the mobile information terminal 400, but also the other in-vehicle apparatus, may prevent such communication.

As described above, according to the in-vehicle system 1001 as set forth in Embodiment 3, in the case of performing driving safety support, the mobile information terminal 400 can be prevented from causing unwanted data delivery, so that it is possible to avoid communication network congestion. Further, since unwanted data delivery is prevented, it is possible to reduce the processing load of the control unit in each of the in-vehicle apparatuses.

In this application, a variety of exemplary embodiments and examples are described; however, every characteristic, configuration or function that is described in one or more embodiments, is not limited to being applied to a specific embodiment, and may be applied alone or in any of various combinations thereof to another embodiment. Accordingly, an infinite number of modified examples that are not exemplified here are supposed within the technical scope disclosed in the present description. For example, such cases shall be included where at least one configuration element is modified; where at least one configuration element is added or omitted; and furthermore, where at least one configuration element is extracted and combined with a configuration element of another embodiment.

### DESCRIPTION OF REFERENCE NUMERALS AND SIGNS

100: in-vehicle communication apparatus, 102: data processing instruction unit, 103, 403: data generation unit, 104, 404: vehicle-external communication unit, 105: application profile management unit, 117, 417: vehicle-internal communication unit, 118, 418: driving support determination unit, 120: control unit, 400: mobile information terminal, 1000: vehicle, 1001: in-vehicle system, 1002: in-vehicle network.

1. An in-vehicle communication apparatus, comprising:
a vehicle-internal communicator that communicates with in-vehicle apparatuses installed in a vehicle through an in-vehicle network;
a vehicle-external communicator that communicates with a vehicle outside apparatus placed outside the vehicle; and
a controller which has:
an application profile manager that determines a combination of apparatuses that are required, respectively, for acquiring input information that is needed for execution of an application and transferring the input information, for executing processing according to the application on a basis of the transferred input information, and for outputting a processing result of the thus-executed processing according to the application; and
a data processing instructor that instructs the apparatuses of said combination determined by the application profile manager, to acquire and transfer the input information, to execute the processing according to the application on the basis of the transferred input information, and to output the processing result of the executed processing;
wherein the application profile manager determines from among the in-vehicle apparatuses and the in-vehicle communication apparatus, the combination of apparatuses that are required, respectively, for acquiring and transferring the input information, for executing the processing according to the application and for outputting the processing result.

2. The in-vehicle communication apparatus as set forth in claim 1, wherein the application profile manager picks out plural sets of apparatuses that might be required for acquiring and transferring the input information, for the processing according to the application and for outputting the processing result, and then compares the plural sets with each other, to thereby determine the combination of apparatuses.

3. The in-vehicle communication apparatus as set forth in claim 2, wherein the application profile manager presets, for each of functions to be required, priorities of apparatuses with respect to the plural sets of apparatuses, to compare respective priorities of the sets of apparatuses with each other, to thereby determine the combination of apparatuses.

4. The in-vehicle communication apparatus as set forth in claim 2, wherein the application profile manager compares said sets with each other on a basis of a criterion of whether a maximum value of load factors of the controller and in-vehicle apparatus controllers included in all of the in-vehicle apparatuses, at the execution of the application, is minimized, to thereby determine the combination.

5. The in-vehicle communication apparatus as set forth in claim 2, wherein the application profile manager compares said sets with each other on a basis of a criterion of whether a load factor of the controller at the execution of the application is minimized, to thereby determine the combination.

6. The in-vehicle communication apparatus as set forth in claim 2, wherein the application profile manager compares said sets with each other on a basis of at least one of criteria of whether accuracy of the result by the execution of the application is maximized and whether reliability of the result by the execution of the application is maximized.

7. The in-vehicle communication apparatus as set forth in claim 1, further comprising an in-vehicle communication apparatus sensor that detects a state of the vehicle;
wherein the controller has a data generator that generates transmission data on a basis of a state of the vehicle detected by at least one of the in-vehicle apparatuses, the state of the vehicle detected by the in-vehicle communication apparatus sensor, and the processing result of the application; and
wherein the vehicle-external communicator transmits the transmission data generated by the data generator to the vehicle outside apparatus.

8. The in-vehicle communication apparatus as set forth in claim 1,
wherein the controller includes a driving support determinator that determines whether or not driving support is necessary;
wherein at least one of the in-vehicle apparatuses include an in-vehicle apparatus controller having an in-vehicle apparatus-side driving support determinator that determines whether or not driving support is necessary;
wherein, when the application is a driving safety support application, the application profile manager determines, out of the driving support determinator and the in-vehicle apparatus-side driving support determinator, a unit as a processing execution target that is subject to execution of determination of whether or not driving support is necessary; and
wherein the data processing instructor instructs the driving support determinator or the in-vehicle apparatus-side driving support determinator determined by the application profile manager, to execute determination of whether or not driving support is necessary.

9. The in-vehicle communication apparatus as set forth in claim 1, wherein the in-vehicle apparatuses installed in the vehicle include a mobile information terminal that is carried by a passenger in the vehicle and communicates with the vehicle-internal communicator through the in-vehicle network.

10. The in-vehicle communication apparatus as set forth in claim 9, wherein the mobile information terminal that communicates with the vehicle-internal communicator through the in-vehicle network has:
a mobile information terminal-side vehicle-internal communicator that communicates with the other in-vehicle apparatuses installed in the vehicle through the in-vehicle network;
a mobile information terminal-side vehicle-external communicator that communicates with the vehicle outside apparatus placed outside the vehicle; and
a mobile information terminal-side data generator that generates transmission data to be transmitted by the mobile information terminal.

11. The in-vehicle communication apparatus as set forth in claim 10, wherein the mobile information terminal that communicates with the vehicle-internal communicator through the in-vehicle network includes a sensor that detects a position and a moving state of the mobile information terminal, to thereby determine whether or not the mobile information terminal is carried by the passenger in the vehicle and, if it is carried by the passenger in the vehicle, stops transmitting through the mobile information terminal-side vehicle-external communicator to the outside apparatus, the position and the moving state of the mobile information terminal detected by the sensor.

12. The in-vehicle communication apparatus as set forth in claim 1,
wherein the vehicle-external communicator receives the application from the vehicle outside apparatus;
wherein the application profile manager in the controller determines the combination of apparatuses that are required, respectively, for acquiring and transferring the input information that is needed for execution of the application, for executing the processing according to the application on the basis of the transferred input information, and for outputting the processing result of the thus-executed processing according to the application; and
wherein the data processing instructor in the controller instructs the apparatuses of said combination determined by the application profile manager, to acquire and transfer the input information, to execute the processing on the basis of the transferred input information, and to output the processing result of the executed processing.

13. An in-vehicle system which comprises the in-vehicle apparatuses and the in-vehicle communication apparatus as set forth in claim 1.

14. An application processing method by an in-vehicle communication apparatus which comprises: a vehicle-internal communicator that communicates with in-vehicle apparatuses installed in a vehicle through an in-vehicle network; a vehicle-external communicator that communicates with a vehicle outside apparatus placed outside the vehicle; and a controller which has an application profile manager and a data processing instructor,
said application processing method comprising:
an application execution allocation determination step in which the application profile manager determines a combination of apparatuses that are required, respectively, for acquiring and transferring input information that is needed for execution of an application, for executing processing according to the application on a basis of the transferred input information, and for outputting a processing result of the thus-executed processing according to the application; and
an application execution instruction step in which the data processing instructor instructs the apparatuses of said combination determined by the application profile manager, to acquire and transfer the input information, to execute the processing on the basis of the transferred input information, and to output the processing result of the executed processing.
